(19) United States
(12) Patent Application Publication
(10) Pub. No.: US 2007/0233885 A1
(43) Pub. Date: Oct. 4, 2007

(54) Architectures for assuring the inter-domain transport of QoS sensitive information

(76) Inventors: Richard W. Buskens, Robbinsville, NJ (US); Sandra Ramos Thuel, Middletown, NJ (US); Ramesh Viswanathan, Manalapan, NJ (US)

Correspondence Address: CAPITOL PATENT & TRADEMARK LAW FIRM, PLLC;ATTN: JOHN CURTIN, P.O. BOX 1995, VIENNA, VA, 22183, US

(21) Appl. No.: 11/393,884

(22) Filed: Mar. 31, 2006

(51) Int. Cl. G06F 15/16

(52) U.S. Cl. 709/230

(57) ABSTRACT

The transport of Quality-of Service (QoS) sensitive information over domains operated by different service providers may be assured using architectures that include separate forwarding and control planes.

### RELATED APPLICATION

The present application is related to co-pending U.S. patent application Ser. No. ______, entitled “Methods and Devices For Computing Paths To Assure The Inter-Domain Transport of QoS Sensitive Information”, the disclosure of which is incorporated by reference herein in full as if set forth in full herein.

### BACKGROUND OF THE INVENTION

Assuring that information is transported from one point to another with a certain quality-of-service (“QoS”), especially when the points are located in different domains (i.e., inter-domain) operated by different service providers, is important to the success of existing services as well as to enable the spread and growth of relatively new services, such as voice-over-Internet protocol (“VoIP”), multimedia and mission-critical services.

The de facto standard for inter-domain routing in today's Internet is Border Gateway Protocol (BGP), which uses so-called BGP speakers to advertise and select paths to destination prefixes (i.e., destinations). BGP is “QoS-agnostic”. That is, in BGP no QoS path related information is exchanged between speakers and all traffic, independent of its QoS requirements, is forwarded along the same selected path. As such, it can be fairly stated that there is no explicit support for the transport of QoS sensitive traffic using the Internet's current infrastructure.

As evidenced by the ‘Infranet’ effort, there is an increasing realization that this is inadequate to support high-revenue, commercial-grade services that require some degree of reliability and quality assurance (i.e., QoS guarantees). Recently, some have attempted to modify BGP to make it less QoS agnostic. Unfortunately, the disadvantages discovered outweigh the advantages.

It is noteworthy that the co-pending Application referenced above sets forth methods (and devices to carry out the methods) that assures QoS sensitive information can be transported over different domains without the disadvantages inherent in BGP just described.

What is yet to be addressed is the architecture of a given domain. That is, what are the architecture(s) that assure the transport of QoS sensitive information over different domains?

### SUMMARY OF THE INVENTION

The present inventors have discovered architectures that assure the transport of QoS sensitive information over multiple, different domains.

In one embodiment of the invention, one such architecture comprises separate control and forwarding “planes”. More specifically, the control plane may comprise one or more devices called “speakers”, each located in a different domain. In accordance with the present invention, each speaker's control plane computes and identifies best paths before QoS sensitive information is forwarded and reserves paths in response to trunk requests and the like. The forwarding plane may comprise one or more other devices, such as border routers, which are responsible for forwarding QoS sensitive information between different domains along best paths computed and identified by the speakers.

In a further embodiment of the invention, the speakers are operable to exchange messages with one another over their control planes. The messages may include information related to possible best paths which may be used to route QoS sensitive information, and/or, may be related to the reservation of one or more best paths. Upon receiving a message, a speaker may use information in these messages to compute and/or reserve best paths.

In accordance with additional embodiments of the invention, the speakers may comprise AQUA (an abbreviation for Assured Quality) speakers.

The embodiments described above are just some examples of the present invention. Other examples are set forth in the drawings and detailed description of the invention which follow.

### BRIEF DESCRIPTION OF THE DRAWINGS

FIG. 1 depicts a simplified diagram of an exemplary architecture provided by the present invention.

### A DETAILED DESCRIPTION OF THE INVENTION, WITH EXAMPLES

The inventors believe that the architectures provided by the present invention may be deployed by service providers that need to cooperate with each other in order to deliver QoS-sensitive services to their customers.

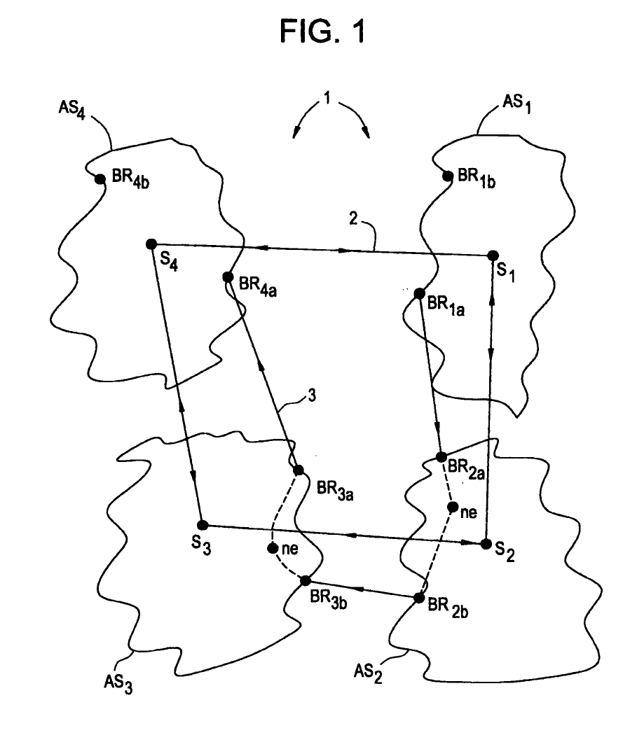

Referring now to FIG. 1, there is shown an architecture 1 for assuring the transport of QoS sensitive information over a plurality of different domains in accordance with one embodiment of the present invention. As shown, the architecture 1 comprises a plurality of domains (each domain may be referred to as an “Autonomous System or “AS”) labeled AS₁, AS₂, AS₃ and AS₄. Within each domain there is depicted an element referred to as a “speaker”, labeled S₁, S₂, S₃ and S₄. A speaker may comprise, for example, an AQUA speaker as set forth in the co-pending Application mentioned above. In an alternative embodiment of the invention, each of the speakers S₁, S₂, S₃ and S₄ may comprise a combination of an AQUA speaker and a BGP speaker, though it should be understood that there is no requirement for such a combination in order to carry out the features and functions of the present invention. However, a service provider may prefer to implement the present invention using such a speaker.

It should be understood that within each domain there is typically a single speaker. Though shown as a separate element within each of the domains in FIG. 1, a speaker may also be a part of another network element, such as a specialized border router or network management element. Further, each speaker may be further separated into multiple components. It should be further understood that a speaker may be implemented in hardware, software, firmware or some combination of the three. Also shown in FIG. 1, are Border Routers (“BR”) associated with each AS (e.g., Border Router BR₁₍ₐ₎, BR_{1(b)} are associated with AS₁; Border Routers BR₂ₐ, BR_{2b} with AS₂; Border Routers BR₃ₐ, BR_{3b}, with AS₃; and Border Routers BR₄ₐ and BR_{4b} with AS₄, etc.).

The architecture 1, as well as other architectures provided by the present invention, comprises two separate layers or “planes”; a (1) control plane and (2) a forwarding plane.

More specifically, the speakers S₁, S₂, S₃ and S₄ connected via pathway 2 comprise a control plane. In accordance with the present invention, the control plane computes and identifies best paths before QoS sensitive information is forwarded and is used to reserve paths in response to trunk requests and the like. In contrast, the Border Routers comprise a forwarding plane that forwards QoS sensitive information over AS₁, AS₂, AS₃ and AS₄ via one or more best paths identified by the control plane.

In order to compute the best paths for routing QoS sensitive information, each of the speakers S₁, S₂, S₃ and S₄ is operable to exchange messages with one another via their respective control planes. Based on information contained in this messages, each speaker S₁, S₂, S₃ and S₄ may compute and identify one or more best paths that may be used to route QoS sensitive information via the separate forwarding planes. The co-pending Application mentioned above sets forth some examples of how speakers S₁, S₂, S₃ and S₄ may compute the best paths using, for example, a stored information base of best paths or an on-demand method of determining best paths. The examples set forth in the co-pending Application are just some of the methods which may be used by the speakers S₁, S₂, S₃ and S₄ to compute and identify possible best paths.

As mentioned above, in one embodiment of the invention, the forwarding plane comprises those elements of the architecture 1 which are responsible for actually forwarding QoS sensitive information from one point to another, such as the border routers mentioned above as well as network elements (“ne”) within each domain to give just a few examples. In accordance with the present invention, the paths used by the forwarding planes (e.g., border routers) to route QoS sensitive information over domains AS₁, AS₂, AS₃ and AS₄ are those best paths computed and identified by the separate control plane of architecture 1. An example of a best path is path 3 shown in FIG. 1. The best path 3 may comprise a so-called “end-to-end reserved tunnel” for transporting QoS-sensitive traffic using MPLS forwarding.

Thus, while no traffic is routed through a speaker S₁, S₂, S₃, S₄, it is the speakers S₁, S₂, S₃, S₄, that: (i) determine which paths are to be used by the forwarding plane to route QoS sensitive information over AS₁, AS₂, AS₃ and AS₄ (i.e., which paths have the bandwidth and delay characteristics required to route the information); (ii) guarantee that the so-selected paths will be reserved; and (iii) reserve best paths in response to trunk requests and the like.

In accordance with embodiments of the present invention, the features and functions of the present invention may be carried out completely independent of any BGP functions, thus assuring that critical BGP functions are not adversely impacted.

The discussion above has set forth some examples of the present invention. However, the true scope of the present invention is better represented by the claims that follow.

We claim:

1. An architecture for transporting QoS sensitive information over a plurality of domains comprising:
separate forwarding and control planes, wherein
the control plane computes and identifies best paths before QoS sensitive information is forwarded, and reserves best paths, and
the forwarding plane forwards the QoS sensitive information over a best path identified by the control plane.

2. The architecture in claim 1 wherein the control plane comprises one or more devices, each device located in a different domain.

3. The architecture in claim 2 wherein each of the one or more devices is operable to exchange messages concerning best paths.

4. The architecture in claim 3 wherein each of the one or more devices is further operable to compute best paths.

5. The architecture in claim 2 wherein one or more of the devices comprises an AQUA speaker.

6. The architecture in claim 2 wherein one or more of the devices comprises an AQUA and BGP speaker.

7. The architecture in claim 1 wherein the forwarding plane comprises one or more devices for forwarding QoS sensitive information over domains using the identified best path.

8. An architecture for transporting QoS sensitive information over a plurality of domains comprising:
a control plane comprising one or more devices, each device located in a different domain, wherein the control plane computes and identifies best paths before QoS sensitive information is forwarded and reserves best paths.

9. The architecture in claim 8 wherein each of the one or more devices is operable to exchange messages concerning best.

10. The architecture in claim 9 wherein each of the one or more devices is further operable to compute best paths.

11. The architecture in claim 8 wherein one or more of the devices comprises an AQUA speaker.

12. The architecture in claim 8 wherein one or more of the devices comprises an AQUA and BGP speaker.

13. An architecture for transporting QoS sensitive information over a plurality of domains comprising:
a forwarding plane for forwarding the QoS sensitive information over different domains using a best path identified by a separate control plane.

14. A method for transporting QoS sensitive information over a plurality of different domains comprising:
separating a forwarding plane from a control plane, wherein
the control plane computes and identifies best paths before QoS sensitive information is forwarded, and reserves best paths, and
the forwarding plane forwards the QoS sensitive information over a best path identified by the control plane.

15. The method as in claim 14 wherein the control plane comprises one or more devices, each device located in a different domain.

16. The method as in claim 15 wherein each of the one or more devices is operable to exchange messages concerning best paths.

17. The method as in claim 16 wherein each of the one or more devices is further operable to compute best paths.

18. The method as in claim 15 wherein one or more of the devices comprises an AQUA speaker.

19. The method as in claim 15 wherein one or more of the devices comprises an AQUA and BGP speaker.

20. The method as in claim 14 wherein the forwarding plane comprises one or more devices for forwarding the QoS sensitive information over the domains using the identified best path.

21. A method for transporting QoS sensitive information over a plurality of domains comprising:
computing and identifying best paths in a control plane before QoS sensitive information is forwarded in a separate forwarding plane and reserving best paths.

22. The method as in claim 21 further comprising exchanging messages concerning best paths.

23. The method as in claim 22 further comprising computing the best paths based on the messages.

24. The method as in claim 21 further comprising:
forwarding QoS sensitive information to domains over a separate forwarding plane using a best path identified by the control plane.
